(19) United States
(12) Patent Application Publication
(10) Pub. No.: US 2022/0081654 A1
(43) Pub. Date: Mar. 17, 2022

(54) LAUNDRY DETERGENT EFFECTIVE FOR USE AGAINST PET STAINS AND ODORS

(71) Applicant: AO, LLC, Ankeny, IA (US)

(72) Inventors: Blake Anderson, Ankeny, IA (US); Mikaela Stanley, Ankeny, IA (US)

(21) Appl. No.: 17/447,924

(22) Filed: Sep. 16, 2021

Related U.S. Application Data
(60) Provisional application No. 63/079,393, filed on Sep. 16, 2020.

(51) Int. Cl. C11D 3/386; C11D 3/00

(52) U.S. Cl. CPC C11D 3/386; C11D 3/0068; C11D 3/0031

(57) ABSTRACT

A detergent is provided for removing pet odors and stains, the detergent including: one or more of a surfactant, a buffering agent, a preservative, an odor absorber, a builder, and an enzyme; and a fragrance that is non-toxic for pets.

### CROSS-REFERENCE TO RELATED APPLICATION(S)

This application claims priority to and is a non-provisional of U.S. Patent Application Ser. No. 63/079,393 for a Laundry Detergent Effective for Use Against Pet Stains and Odors filed on Sep. 16, 2020, the contents of which are incorporated herein by reference in its entirety.

### FIELD

This disclosure relates to the field of pet products. More particularly, embodiments of the present disclosure relate to a detergent that is specifically effective for pet odors and stains and that is also safe for pets.

### BACKGROUND

Various detergents and cleaning products exist that may be used for cleaning. Many of these existing detergents are formulated for use with humans, such as cleaning clothes or various laundry, targeted at odors and stains made by humans with scents that are safe for humans. Similarly, although other products such as stain and odor removers exist for removing pet stains, such products are not typically formulated to be safe for pets or provided in the form of a detergent. Instead, most existing detergents target stains and odors in a way that is not effective against pet odors and stains but generally only suitable for humans, not against pet odors and stains such as feces, urine, blood, or other pet related odors and stains. Also, most existing detergents are only suitable for or targeted to humans with respect to the safety of the pet, pet fragrance sensitivity, and pet related grievances.

Further, pets, such as dogs, may have a sense of smell that is up to fifty times more sensitive than a human's sense of smell. Certain scents and fragrances that are suitable for human use may be unsuitable and in some instances toxic for a pet's sense of smell. For example, some scents or fragrances may cause drooling, lethargy, ataxia, tremors, seizures, and allergic reactions in pets such as dogs and cats. Further, harmful ingredients to pets may cause problems with a pet's nervous, digestive, respiratory, endocrine, and other bodily systems of the pet.

What is needed, therefore, is a detergent for use with pet laundry that is formulated to effectively target specific pet stains and odors and still be safe for use with pets such as by including scents that are safe for pets.

### SUMMARY

The above and other needs are met by a detergent for use with pet laundry that is formulated to effectively target specific pet stains and odors and still be safe for use with pets such as by including scents that are safe for pets. In a first aspect, a detergent for removing pet odors and stains includes: a surfactant, a buffering agent, a preservative, an odor absorber, a builder, and an enzyme; and from about 0.1 to about 5 percent, by weight, of a fragrance that is non-toxic for pets.

In one embodiment, the surfactant is selected from the group consisting of: C10-16 Alkylpolyglucoside, lauramine oxide, and decyl glucoside. In another embodiment, the fragrance comprises an essential oil. In yet another embodiment, the fragrance is selected from the group consisting of but not limited to: chamomile, lavender, vanilla, honey, lemongrass.

In one embodiment, the odor absorber is selected from the group consisting of one or more of but not limited to: zinc ricinoleate, sodium lauroyl sarcosinate, tetrahydroxypropyl ethylenediamine, zinc chloride, and beta-cyclodextrin.

In another embodiment, the enzyme is selected from the group consisting of one or more of but not limited to: protease, amylase, alpha amylase, mannanase, pectate lyase, lipase, cellulase, savinase, ammonia monooxygenase, and hydroxylamine oxidoreductase. In yet another embodiment, the detergent is contained within a capsule.

In a second aspect, a detergent is provided for removing pet odors and stains, the detergent comprising: a surfactant selected from the group consisting of one or more of but not limited to: C10-16 Alkylpolyglucoside, lauramine oxide, and decyl glucoside; a buffering agent selected from the group consisting of one or more of but not limited to: glycerol oleate, sodium gluconate, sodium chloride, sodium citrate, sodium carbonate, sodium borate; a preservative; an odor absorber selected from the group consisting of one or more of but not limited to: odor absorber selected from the group consisting of one or more of but not limited to: zinc ricinoleate, sodium lauroyl sarcosinate, tetrahydroxypropyl ethylenediamine, zinc chloride, and beta-cyclodextrin; a builder; an enzyme selected from the group consisting of one or more of but not limited to: protease, amylase, alpha amylase, mannanase, pectate lyase, lipase, cellulase, savinase, ammonia monooxygenase, and hydroxylamine oxidoreductase; and a fragrance selected from the group consisting of but not limited to: chamomile, lavender, vanilla, honey, lemongrass.

In one embodiment, the builder includes one or more of but not limited to water, citric acid and hydrated silica.

In a third aspect, a detergent is provided for removing pet odors and stains, the detergent comprising: a surfactant selected from the group consisting of one or more of but not limited to: C10-16 Alkylpolyglucoside, lauramine oxide, and decyl glucoside; a buffering agent selected from the group consisting of one or more of but not limited to: glycerol oleate, sodium gluconate, sodium chloride, sodium citrate, sodium carbonate, sodium borate; a preservative; an odor absorber selected from the group consisting of one or more of but not limited to: odor absorber selected from the group consisting of one or more of but not limited to: zinc ricinoleate, sodium lauroyl sarcosinate, tetrahydroxypropyl ethylenediamine, zinc chloride, and beta-cyclodextrin; a builder; and an enzyme selected from the group consisting of one or more of but not limited to: protease, amylase, alpha amylase, mannanase, pectate lyase, lipase, cellulase, savinase, ammonia monooxygenase, and hydroxylamine oxidoreductase.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Embodiments herein relate to a detergent that is effective for use with pets and washable pet items, such as being effective against pet odors (such as pet body odor, pet urine odor, pet feces odor, and other common pet odors) and pet stains (such as pet urine, pet feces, pet blood, and other pet-related stains) while also being safe for use with pets. The detergent described herein may be in the form of a liquid or powder, in a capsule such as a film capsule or pod, or in other suitable delivery methods for use during cleaning of items that a pet is likely to contact. The detergent may be used by placing the detergent, which may be in powder, capsule, or other delivery methods described herein, into a washing machine for cleaning of pet products or products used by pets with embodiments of the detergent described herein.

Embodiments of the detergent preferably include one or more naturally derived surfactants, naturally derived buffering agents, at least one biodegradable preservative, a de-odorizing compound, one or more builders, one or more enzymes, and one or more essential oil fragrances, effective against pet stains and odors.

Suitable naturally-derived surfactants include, for example, C10-16 Alkylpolyglucoside, lauramine oxide, and decyl glucoside. The one or more naturally-derived surfactants are suitable for use due to their low toxicity. Various chemical-based surfactants may also be suitable for use.

The detergent further preferably includes one or more naturally derived, such as from plants, buffering agents for maintaining a desired pH level of the detergent. Suitable naturally derived buffering agents may include, for example, glycerol oleate, sodium gluconate, sodium chloride, sodium citrate, sodium carbonate, sodium borate, and other suitable naturally-derived buffering agents. One or more of the above or other suitable naturally-derived buffering agents may be included in amounts suitable to maintain a desired pH level of the detergent based on other compounds included therein.

At least one, preferably biodegradable, preservative is preferably included in the detergent to help prevent decay of the detergent. A suitable biodegradable preservative may include, for example, benzisothiazolinone. Another suitable preservative may be, for example, Methylisothiazolinone.

The detergent further may include a, preferably renewable, de-odorizing ingredient that is preferably natural for removing odors. The renewable de-odorizing ingredient may one of or a blend of two or more suitable odor absorbers such as zinc ricinoleate, sodium lauroyl sarcosinate, tetrahydroxypropyl ethylenediamine, zinc chloride, beta-cyclodextrin, and other suitable odor absorbing compounds.

Embodiments of the detergent further preferably include one or more builders for further maintaining a desired pH level of the detergent. Exemplary builders suitable for the detergent may include one or more of citric acid and hydrated silica.

The detergent further preferably includes one or more enzymes. The one or more enzymes may be, for example, protease, amylase, alpha amylase, mannanase, pectate lyase, lipase, cellulase, savinase, ammonia monooxygenase, and hydroxylamine oxidoreductase. One or more of the foregoing enzymes or other suitable enzymes are preferably included in the detergent in an amount suitable to further facilitate cleaning of pet odors and stains with the detergent. The detergent may include one of the foregoing and other suitable enzymes, or alternatively may include a blend or combination of various suitable enzymes.

In one embodiment, one or more essential oil fragrances are included in the detergent for adding scent while being safe for use with items for pets. Exemplary essential oil fragrances include chamomile, lavender, vanilla, honey, lemongrass, and other similar fragrances. Other suitable essential oil fragrances may be used in the detergent in amounts such that the fragrances are safe for use with pets. Alternatively, one or more scents may be added that are not essential oils but that may also be safe for use with pets, such as scents that provide an overall safe environment for a pet to chew, lay, wear, smell, or otherwise enjoy a washed product safely without impacting health of the pet, such as without causing seizures, drooling, lethargy, ataxia, tremors, seizures, and allergic reactions in pets such as dogs and cats. By using ingredients that create scents that are safe for pets, pet products may be cleaned that may otherwise be avoided with the use of laundry detergents having dyes, fragrances/perfumes, and chemicals that are harsh to pets, thereby allowing the pet products to be cleaned to have a pleasant smell to both pet owners and the pets. In another embodiment, the detergent may be substantially un-scented while still providing suitably safe cleaning for pets.

Embodiments of the detergent described herein advantageously provide cleaning of items used for pets by targeting specific stains and odors from pets, without adding scents or otherwise harming pets after cleaning of the items with the detergent. The detergent provides a detergent that is effective against pet-related odors and stains, while also providing a pet safe product that is low in toxicity and safe for use with pets based these preferably described ingredients.

### EXAMPLE 1

In one exemplary embodiment, a detergent may be composed of the following: from about 1 to about 20 percent by weight of water; from about 5 to about 40 percent by weight of C10-16 Alkylpolyglucoside; from about 5 percent to about 40 percent by weight of lauramine oxide; from about 0.11 percent to about 20 percent by weight of propanediol; from about 0.11 percent to about 20 percent by weight of deoconcentrate; from about 0.1 percent to about 20 percent by weight of augeo clean multi; from about 0.1 percent to about 10 percent by weight of caboxyline 25-40 D; from about 1 percent to about 9 percent by weight of glyceryl oleate; from about 0.1 to about 5 percent by weight of beta-cyclodextrin; from about 0.1 percent to about 3 percent by weight of hydrated silica; from about 0.1 percent to about 5 percent by weight of sodium carbonate; from about 0.1 percent to about 5 percent by weight of sodium carbonate peroxide; from about 0.1 to about 3 percent by weight of sodium citrate; from about 0.1 to about 5 percent by weight of sodium chloride; from about 0.001 to about 1 percent by weight of citric acid; from about 0.1 to about 3 percent by weight of sodium gluconate; from about 0.01 to about 3 percent by weight of benzisothiazolinone; from about 1 percent to about 10 percent by weight of medley select 200 (which may be a blend of protease in the form of Subtilisin, alpha-amylase, pectate lyase, mannanase, cellulase); from about 0.1 percent to about 5 percent by weight of savinase; from about 0.1 percent to about 0.5 percent by weight of lipase; and from about 0.1 to about 5 percent by weight of lavender & chamomile #04-20-84758. The above exemplary embodiment may be provided in the form of a pod or capsule.

### EXAMPLE 2

In another example, an embodiment of the detergent described herein that is substantially unscented may comprise the following: from about 1 to about 20 percent by weight of water or oil; from about 30 to about 60 percent by weight of one or more surfactants; from about 10 to about 30 percent by weight of one or more solvents; from about 1 to about 6 percent by weight of one or more odor neutralizers or absorbers; from about 4 to about 8 percent by weight of one or more preservatives; and from about 0.5 to about 4 percent by weight of one or more enzymes. The detergent may optionally include from about 0.1 to about 5 percent by weight of a fragrance depending on whether the detergent is desired to be scented or unscented.

The above examples are for illustrative purposes, and it is understood that the above amounts and types of compounds may be varied using other suitable elements. Further, some elements may be omitted or added without substantially reducing effectiveness of the detergent. For example, fragrances and other element may be substitute for other suitable substances. Embodiments of the detergent described herein may be suitable for removing pet stains and odors.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A detergent for removing pet odors and stains, the detergent comprising:
one or more of:
a surfactant,
a buffering agent,
a preservative,
an odor absorber,
a builder, and
an enzyme; and
from about 0.1 to about 5 percent, by weight, of a fragrance that is non-toxic for pets.

2. The detergent of claim 1, the surfactant selected from the group consisting of but not limited to: C10-16 Alkylpolyglucoside, lauramine oxide, and decyl glucoside.

3. The detergent of claim 1, wherein the fragrance comprises an essential oil.

4. The detergent of claim 3, wherein the fragrance is selected from the group consisting of: chamomile, lavender, vanilla, honey, lemongrass.

5. The detergent of claim 1, the odor absorber selected from the group consisting of one or more of: zinc ricinoleate, sodium lauroyl sarcosinate, tetrahydroxypropyl ethylenediamine, zinc chloride, and beta-cyclodextrin.

6. The detergent of claim 1, the enzyme selected from the group consisting of one or more of: protease, amylase, alpha amylase, mannanase, pectate lyase, lipase, cellulase, savinase, ammonia monooxygenase, and hydroxylamine oxidoreductase.

7. The detergent of claim 1, wherein the detergent is contained within a capsule.

8. A detergent for removing pet odors and stains, the detergent comprising:
a surfactant selected from the group consisting of one or more of: C10-16 Alkylpolyglucoside, lauramine oxide, and decyl glucoside;
a buffering agent selected from the group consisting of one or more of: glycerol oleate, sodium gluconate, sodium chloride, sodium citrate, sodium carbonate, sodium borate;
a preservative;
an odor absorber selected from the group consisting of one or more of: odor absorber selected from the group consisting of one or more of: zinc ricinoleate, sodium lauroyl sarcosinate, tetrahydroxypropyl ethylenediamine, zinc chloride, and beta-cyclodextrin;
a builder;
an enzyme selected from the group consisting of one or more of: protease, amylase, alpha amylase, mannanase, pectate lyase, lipase, cellulase, savinase, ammonia monooxygenase, and hydroxylamine oxidoreductase; and
a fragrance selected from the group consisting of: chamomile, lavender, vanilla, honey, lemongrass.

9. The detergent of claim 8, the builder comprising one or more of citric acid and hydrated silica.

10. A detergent for removing pet odors and stains, the detergent comprising:
a surfactant selected from the group consisting of one or more of: C10-16 Alkylpolyglucoside, lauramine oxide, and decyl glucoside;
a buffering agent selected from the group consisting of one or more of: glycerol oleate, sodium gluconate, sodium chloride, sodium citrate, sodium carbonate, sodium borate;
a preservative;
an odor absorber selected from the group consisting of one or more of: odor absorber selected from the group consisting of one or more of: zinc ricinoleate, sodium lauroyl sarcosinate, tetrahydroxypropyl ethylenediamine, zinc chloride, and beta-cyclodextrin;
a builder;
an enzyme selected from the group consisting of one or more of: protease, amylase, alpha amylase, mannanase, pectate lyase, lipase, cellulase, savinase, ammonia monooxygenase, and hydroxylamine oxidoreductase.
